(19) United States
(12) Patent Application Publication
(10) Pub. No.: US 2009/0144083 A1
(43) Pub. Date: Jun. 4, 2009

(54) Healthcare Exchange II

(76) Inventor: Anuthep Benja-Athon, New York, NY (US)

Correspondence Address: Anuthep Benja-Athon, 210 E 36th St., New York, NY, 10016, US

(21) Appl. No.: 12/322,529

(22) Filed: Feb. 4, 2009

Related U.S. Application Data
(63) Continuation-in-part of application No. 12/080,433, filed on Apr. 3, 2008.
Application No. 12/080,433 is a continuation-in-part of application No. 12/072,097, filed on Feb. 25, 2008.
Application No. 12/072,097 is a continuation-in-part of application No. 12/069,409, filed on Feb. 11, 2008.
Application No. 12/069,409 is a continuation-in-part of application No. 11/059,088, filed on Feb. 16, 2005.
Application No. 11/059,088 is a continuation-in-part of application No. 11/344,485, filed on Feb. 1, 2006.
Application No. 11/344,485 is a continuation-in-part of application No. 11/293,689, filed on Dec. 5, 2005.
Application No. 11/293,689 is a continuation-in-part of application No. 11/242,461, filed on Oct. 4, 2005.
Application No. 11/242,461 is a continuation-in-part of application No. 11/074,236, filed on Mar. 7, 2005.
Application No. 11/074,236 is a continuation-in-part of application No. 11/114,763, filed on Apr. 27, 2005.

(51) Int. Cl. G06Q 50/00; G06Q 40/00; G06Q 90/00

(52) U.S. Cl. 705/2; 705/30; 705/40; 705/35

(57) ABSTRACT

A system and method for controlling health-care resources by physicians, patients and health-care buyers effect by an innovative computer program and software, the use of certain words and terms in health and health-care generated and submitted by physicians and a network or networks of computers and servers.

This application is a continuation-in-part of Ser. No. 12/080,433 entitled The healthcare exchange filed Apr. 3, 2008 which is a continuation-in-part of Ser. No. 12/072,097 entitled A method of empowering owners of health-care resources filed Feb. 25, 2008, a continuation-in-part of Ser. No. 12/069,409 entitled the Filing of health and health-care data filed Feb. 11, 2008, a continuation-in-part of Ser. No. 11/059,088 entitled The consumers-buyers-physicians-directed health-care filed Feb. 16, 2005, a continuation-in-part of Ser. No. 11/344,485 entitled Physicians-patients-health-care-buyers accounting system filed Feb. 1, 2006, a continuation-in-part of Ser. No. 11/293,689 entitled System of conserving health-care buyers' resources, a continuation-in-part of Ser. No. 11/242,461 entitled A perfect system of compensations for physicians filed Oct. 4, 2005, a continuation-in-part of Ser. No. 11/074,236 entitled A system of management of health-care resources filed Mar. 7, 2005, a continuation-in-part of Ser. No. 11/114,763 entitled A System of Influencing Health-Care Utilizations filed Apr. 27, 2005 and ABA0109 filed Jan. 16, 2009 entitled The Best System of Health and Health-care Data Management which are pending.

### FIELD OF INVENTION

A method of controlling health-care resources by physicians, patients and health-care buyers.

### BACKGROUND OF THE INVENTION

The current health-care system conceived and supported by the archaic system widely use in America is inefficient and, over the decades, has grown into an even more inefficient system which degrades the quality of health-care for people, hinders and impedes the health-care progresses and advancements, increase costs for people, keeps health-care costs high and escalating the health-care costs, impose emotional, physical and financial stresses on physicians, patients and companies and corporations, lowers the standard of living and quality of life and, in tangible terms, wastes hundreds of billions of dollars per annum. Physicians, patients, companies, corporations, Congress, government—alone or combined with immensely vast resources—have heretofore neither know-how nor means to free themselves left alone tackle these crises they are in. Recent enacted laws and regulations have not provide the solution to the enormous crisis being faced by American people. For example, the consumer-directed health-care system such as, but not limited to, the Health Savings Account and the Health Reimbursement Arrangement, since its inception in the 1990's have only several million American participants experiencing numerous severe handicaps.

However, the present invention is a vital component part of the unique and innovative systems and methods for solving said problems and crises of the present patent applicant and his co-inventors and together with the pending inventions of the present patent applicant and his co-inventors contribute to the solution to said problems and crises.

Therefore, the present invention is the unique method and innovative system for solving the health-care crises in America wherein physicians, patients and health-care buyers have the one and only means for directly controlling, allocating, accounting and influencing their resources while reducing or eliminating interferences, hindrances and hundreds of billions of dollars of wastes and losses. The benefits to hundreds of millions of people including physicians, patients and health-care buyers—who are heretofore free from their decades-long and escalating pain and suffering—and the nation are enormously immense.

### SUMMARY OF THE INVENTION

The present invention is a vital linchpin of an innovative health-care system wherein hundreds of millions of physicians, patients and companies take control of their resources to improve the health-care system to benefit themselves and health-care.

The present invention provides a system and method for controlling health-care resources by physicians, patients and health-care buyers enable by an innovative computer program and software wherein health, health-care and health-care service information and data including and comprising vital words and terms used, use and generated and submitted by physicians are related, manipulated and processed and relate to same, similar and/or equivalent information and data and relating monetary values generated, related, entered into and store in the database or databases for generating, managing, accounting and displaying information and data on payments or compensations for health-care and health-care services provided to patients by physicians and on the deposits of and debits, deductions and/or disbursements from patients' and health-care buyers' deposits and/or funds corresponding to said payments or compensations for said health-care and health-care services to said physicians by and/or on the behalf of said patients and by and/or on the behalf of said health-care buyers in a network or networks of computers and servers.

### DESCRIPTION OF THE PREFERRED EMBODIMENTS

The present invention is a system and a method for physicians, patients and health-care buyers to control their health-care resources and either reduce or eliminate the interferences and hindrances of and tremendous wastes and losses per annum present in the current health-care system.

The present invention provides the use of data on health-care services provided to the patients by said physicians which are components of the health and health-care data and information on said patients generated by said physicians and input into computers and computer server or servers and the same or equivalent data on health-care services and relating monetary values representing prices or monetary values of said services in the databases in said computer server or servers in a network or networks of said computers and computer servers and a computer program means for using said data on health-care services, said same or equivalent data on health-care services and relating monetary values to effect the generations of data on physicians' accounts comprising data on credits or payments for the health-care services provided to patients by said physicians, data on said patients' accounts comprising data on the disbursements of funds of said patients' accounts relating to said data on said credits or payments and said health-care services and data on health-care buyers' accounts comprising data on the disbursements of funds of said buyers' accounts relating to said data on said credits or payments and disbursements

The present invention is a system and a method of relating data on the credits representing payments and total payments relating to time credited to the physicians' accounts for the health-care services provided to patients by said physicians and data on the debits, deductions or disbursements of patients' and health-care buyers' funds—and fund disbursements and balances relating to time—corresponding to or representing said payments for said services to said physicians by or on the behalf of said patients and by or on the behalf of the health-care buyers in a computer server or computer servers in a network or networks of computers and computer servers.

The present invention provides data on health-care services provided to patients by physicians which are components of the health and health-care data and information on patients generated by physicians and input into the computers in a network or networks of computers and computer servers and the uses of said data on health-care services and the uses of same or equivalent data on health-care services and relating monetary values representing prices or monetary values of said services in the databases in said computer server or servers to effect the insertions of said data into the database or databases comprising the accounts of said physicians comprising data on said credits and payments credited to said physicians and relating to said debits or disbursements, the accounts of said patients comprising data on deposits and said debits or disbursements relating to said payments and the accounts of the health-care buyers comprising data on deposits and said debits and balances of funds relating to said payments or disbursements.

One of the preferred embodiments of the present invention—a unique innovation of the present invention and supports by the unique and innovative computer programs created by the present invention physician applicant—is the unique and innovative uses, processing and applications of the data on the health-care services—components of the health and health-care data and information on patients generated by physicians and taught in the pending applications of the present invention applicant and his other earlier co-applicants—comprise main words, terms, phrases and sentences in the data on health-care services and the same or equivalent data on health-care services and relating monetary values representing prices or costs of said services in the database or databases and the relationship of said data on health-care services and said same or equivalent data on health-care services in the database or databases.

In other words, although the general trends of the generations of said data on health-care services by thousands of physicians in about 85 medical and surgical specialties are for said physicians to predictably use means for producing or generating common words, terms, phrases and sentences—based on the common medical and surgical structures of words, terms, phrases and sentences use by physicians in their practices—matching same, equivalent or similar data on and data structures of health-care services created in the database or databases. However, the present invention covers said data on health-care services in order to compensate for any deviations from said trends such as, but not limited to, variations including errors in and to match said data on health-care services generated by said physicians to said same or equivalent data on health-care services and relating monetary values representing prices or costs of said services in the database or databases to achieve the goals and objectives of the present invention, the present invention necessarily provides the innovative computer programs which process or manipulate said data on health-care services generated by physicians to conform or match to said same or equivalent data on health-care services and relating monetary values representing prices or costs of said services in the database or databases.

To account for and compensate for the variations and errors in the data on health-care services generated by physicians, first, the present invention provides computer program means for compensating and correcting errors in said data. Second, the present invention provides same or equivalent data as said data on health-care services comprises words, terms and phrases in the database or databases so that the computer programs infra designed by the present patent applicant can achieve the processes using matches of said processed data and said same or similar data in the databases described herein.

In one of the preferred embodiments of The Healthcare Exchange filed Apr. 3, 2008 by the present patent applicant, the innovative computer program and software further account and compensate for the variations of said words, terms, phrases and sentences such as, but not limited to, the variations in the numbers of words, terms, phrases and sentences, the relative positions of said words, terms and phrases, the relative positions of words and terms in sentences, and the variations of lengths and sentences, and also errors associating with words, terms, phrases and sentences in said data generated and input by said physicians.

Furthermore, first, said computer programs also find and manipulate words representing sidedness in said data on health-care services associate with said main words, terms, phrases and sentences such as, but not limited to, prefixes “left”, “right”, “both”, “bilateral”, “ipsilateral”, “contralateral” and “multiple”, etc. to match said main words, terms, phrases with same or equivalent words, terms and phrases relating to monetary values infra in said database or databases. For example, a phrase in said data on health-care services generated and in put by a physician may be “left knee arthroscopy” which are processed by said computer programs to be used as “knee arthroscopy” matching same or equivalent “knee arthroscopy” and “knee” “arthroscopy” in said database or databases.

Furthermore, second, said computer programs also find and manipulate the prepositions such as, but not limited to, “and”, “by”, “in”, “on”, “with”, “for”, “the”, “a”, “an” and “of”, etc., present in said data on health-care services. Said computer programs also find and manipulate plurals and certain alphabetical endings of said words, terms, phrases and sentences in said data on health-care services in order to enable the matches of said data on health-care services with the same or equivalent data on health-care services and relating monetary values representing prices or monetary values of said services in the database or databases. For example, a phrase in said data on health-care services generated and in put by a physician may be “the left knee arthroscopy” or “the arthroscopy of the left knee” which are processed by said computer programs to be used as “knee arthroscopy” and “arthroscopy” “knee” matching same or equivalent “knee arthroscopy” and “knee” “arthroscopy” in said database or databases.

Furthermore, third, said computer programs also find and manipulate plural endings and plurals of words and terms and the words and terms in phrases and sentences to match said same or equivalent singulars—word singulars and term singulars—in said databases. For example, a phrase in said data on health-care services generated and in put by a physician may be “surgeries of bilateral knees” which are processed by said computer programs to be used as “surgery knee” matching same or equivalent “surgery knee” and “knee” “surgery” in said database or databases. In these instances, said computer programs are created to know to price a knee surgery and to price yet another price accounting for surgeries of two knees, etc.

To understand the preferred embodiments of the present invention, it is necessary herein to mention that other pending patent applications of the present patent applicant have taught the use and implementation of the categories, headers or headings such as, but not limited to, Evaluation, Chief Complaint, Diagnosis, Treatment, Procedure, Surgery, Medication and Laboratory to enable and/or facilitate the organization, manipulation, processing and relating of health, health-care and health-care services generated and submitted by physicians in about 85 medical and surgical specialties. Each said heading encompasses a vast amount of information and data on health, health-care and health-care service including words and used and use by physicians of all and diverse medical and surgical practices or specialties for and in the communications of said information and data among and between said physicians and between physicians and patients and medical record keeping. For example, under Evaluation heading, said words and terms number about 20-40 or more and are such as, but not limited to, consultation, brief consultation, intermediate consultation, comprehensive consultation, office visit, brief office visit, intermediate office visit, examination, reexamination, follow-up, etc.; under the heading of Laboratory comprises imaging, blood and tissue tests, analyses and examinations, electrodiagnosis, said words and terms number approximately many hundreds such as, but not limited to, x-rays, MRI's, CTScan's, PET Scans, various types of blood tests, urinalyses, pathological analyses which are used by physicians in about 85 medical and surgical specialties or practices. However, under each of other said headings, said words and terms are very extensive. For example, under Diagnosis heading, there are all words and terms used and use by physicians in about 85 medical and surgical specialties on diagnoses of human diseases, illnesses and disorders; under Treatment heading, there are all words and terms used and use by physicians in about 85 medical and surgical specialties on the treatments of human diseases, illnesses and disorders such as, but not limited to, medical acupuncture, incision drainage, trigger point injection, bursa injection, etc.; under Surgery heading, there are all words and terms used and use by physicians in about 85 medical and surgical specialties on the surgeries and surgical procedures of human diseases, illnesses and disorders such as, but not limited to, burr hole, craniotomy, cholecystectomy, arthroscopy, endoscopy, resection, etc.; under Medication heading, there are all medications and related information present in the Physicians' Desk Reference used and use by physicians in about 85 medical and surgical specialties. Anatomical structures and names are also used

Further to supra, one of the preferred embodiments of the present invention is the generation, relating and storage of said words and terms—same, similar and/or equivalent to said words and terms generated and submitted by said physicians as described supra—in said database or databases and have been generated and implemented by the present patent applicant and the quantity of said words and terms will continue to grow and enlarge as more words and terms are generated, entered and stored in said database or databases.

Further to supra, said words and terms store in said database or database relate monetary values representing prices or monetary values of said health-care and health-care services generated, related and stored in said database or databases. Similar to supra, said words and terms and relating monetary values or prices have been generated and implemented by the present patent applicant and the quantity of said words and terms will continue to grow and enlarge as more words, terms, prices or monetary values are generated, entered and stored in said database or databases. Said prices or monetary values are the billing rates—the costs or prices—for health-care and health-care services represent by the fees and payments for items represent by said words and terms for about 85 medical and surgical specialties such as neurology, orthopaedics, general surgery, etc. can be established as data in the database or databases and frequently added and/or edited.

To understand one of the preferred embodiments of the present invention entitled The Healthcare Exchange II, it is necessary to mention one of the preferred embodiments of ABA0109 filed entitled Jan. 16, 2009 entitled The Best System of Health and Health-care Data Management by the present patent applicant wherein a method of using interactive and related electronic templates created, maintain and operate by an innovative computer program for generating, storing, relating, manipulating, updating and expanding health, health-care and health-care service information and data on patients by physicians as taught by ABA0109, said information and data on health, health-care and health-care services including said words and terms, and phrases are much more, definite or better defined by said computer program and software so that there are less to almost no variations in information and data on health, health-care and health-care service on patients generated and submitted by said physicians as templates of said information and data including said words and terms are available to said physicians to use for generating said information and data on health, health-care and health-care service including and comprising words and terms. In other words, ABA0109 provides generated said information and data including and comprising said words and terms to be used by said physicians although physicians still have the option of generating their own said information and data. Therefore, in one of the preferred embodiments of the present invention, there are relatively less manipulations and processing of information and data on health, health-care and health-care service including words and terms submitted by said physicians. Thus, said computer program and software are able to manipulate, process, relate and inserting said information and data including said words and terms into said database or databases, and to scan and process said words and terms and match said words and terms with same, similar, equivalent words and terms store in said database or databases.

One of the many examples is schematically shown as follows:

Evaluation˜extended consultation
Chief Complaint˜headache 5 days
Review of Systems No rash, no fever, productive cough
Physical Examination Skin rash, malaise, running rose
Diagnosis common cold
Infectious Diseases upper respiratory infection
Differential Diagnosis common cold; sinusitis
Laboratories sinus x-ray
Assessment and Plan Common cold; rhinoviral infection
Medications tylenol˜650˜mg˜po˜qid˜20 tabets
Treatment flu vaccine˜one dose˜one vaccination˜stat
Surgery none
Recommendation call if not better
Referral see infectious disease physician
Follow-Up telephone call in the morning

Thus one of the preferred embodiments of the present invention wherein said words and terms in said information and data generated and submitted by said physicians are related, manipulated, processed and related so that said words and terms—bold infra wherein bold words and terms relate to words and terms and relating prices or costs in said database or databases—generated by a physician are to match with same, similar and/or equivalent words and terms generated and stored in said database or databases and is schematically and briefly shown as follows:

Evaluation˜extended consultation
Chief Complaint˜headache 5 days
Review of Systems No rash, no fever, productive cough
Physical Examination Skin rash, malaise, running rose
Diagnosis common cold
Infectious Diseases upper respiratory infection; flu;
Differential Diagnosis common cold; sinusitis;
Laboratories sinus x-ray
Assessment and Plan Common cold; rhinoviral infection
Medication tylenol˜650˜mg˜po˜qid˜20 tablets
Treatment flu vaccine˜one dose˜one vaccination˜stat
Surgery none
Recommendation call if not better
Referral see infectious disease physician
Follow-Up telephone call in the morning

In other words, said headings and delimitors such as, but not limited to, punctuations and various symbols available in most common programs and software as shown drop-down menus in the “Insert” of WordPerfect 12 and also on the computer keyboards such as, but not limited to, “˜”, “,” and “;” are not considered in processes supra and infra such as, but not limited to, matching of said words and terms leading to the process of generating payments, compensations, debits and disbursements, etc. as described infra. Further to supra, many prefixes and suffixes associate with said words and terms are similarly processed. It is to be understood that numerous preferred embodiments of the present invention can be had by either adapting or improving an innovative computer program and software infra invented and developed by the present patent applicant.

Although it may not be necessary, however, the present invention generated and implemented the organization of said words and terms and related monetary values or prices according to about 85 medical and surgical specialties to improve or optimize the efficiency of the function of said computer programs and software and their derivative or derivatives.

Consequent to the incorporations of said data and information using computer programs, software mentioned herein and the like, the products of said incorporations are stored in and retrieved from database or databases to be displayed on the viewing screens and comprehensible and use by patients and physicians.

Furthermore, said innovative computer programs also effect the scanning, relating and matching said vital data, words and terms with the uniquely created same or similar data on health-care services in the database or databases encompassing data on health-care services of about 85 medical and surgical specialties or practices so that said data match, are same or similar. Said innovative computer programs insert of said data on health-care services and the outcomes of said processes and relating monetary values into said physicians' accounts, and patients' and health-care buyers' accounts in said database or databases. Furthermore, said computer programs also effect the insertions of said data and data on the credits representing payments of said services to said physicians and the data on the debits of funds or disbursements representing said payments of said services by said patients and health-care buyers into the database or databases comprising the accounts of said physicians comprising data on said credits and payments credited to said physicians by or on the behalf of said patients and by or on the behalf of the health-care buyers and relating to said debits or disbursements, the accounts of said patients comprising data on deposits and said debits or disbursements relating to said payments and the accounts of the health-care buyers comprising data on deposits and said debits and balances of funds relating to said payments or disbursements in said computer server or servers.

Furthermore, said computer programs and software effecting said relations of said data and also—effect the related displays of payments and total payments are viewable and monitored by said physicians and wherein said items of services and related payments, debits and balances are viewable and monitored by said patients and, appropriately, by said health-care buyers.

Said computer programs and software effecting said relations of said data, furthermore, also effect the feedbacks or exchanges of information such as, but not limited to, disputes, disaccords and the like relating to said credits, payments, debits, disbursements, refunds or reimbursements and balances between physicians, patients and health-care buyers. The settlements of disputes or disaccords of charges and payments and the like and derivatives resulting in the credits, refunds and transfer of funds between accounts of said people and the present invention enables said fulfillment which is viewable and useable by said people on the viewing screens of the computers and mobile communication devices.

It is to be understood that said deposits by patients including their families and dependents and health-care buyers are to be repetitive and perpetual in order for said parties to maintain positive fund balances to meet their payment obligations and to purchase health-care and health-care services as health-care and health-care services are provided to them by physicians. Thus, the present invention provides the means for depositing funds to achieve the goals and objectives of the present invention.

Moreover, the present invention provides an innovative method for physicians to correct erroneous entries of said information and data. This embodiment is achieved by the present invention providing said computer programs and software for correcting erroneous entries of said data by physicians. For example, errors such as, but not limited to, entries of erroneous information and or any misspellings or mismatches of said data of health-care services generated by said physicians and data of health-care services in the database or databases may result in incompletions of said processes or transactions. In these settings, notices are generated to inform said physicians of said deficiencies or defects and said program means permit physicians to correct said errors or reenter correct data and information to fulfill the objectives of the present invention.

It is further understood that further to supra, in addition to said words, terms, phrases and sentences, digits and alphanumerics can and are also used—albeit far less commonly than the uses and applications of said words, terms, phrases and sentences—in said information and data on health, health-care and health-care services provided to patients generated by physicians and said data on health-care services relate to same or equivalent data on health-care services and relating monetary values representing prices or monetary values of said services in the database or databases. In this setting, it is understood that the above can be and is adapted to incorporate this variation present in said data and information.

The method, processes, platform, matters, products, functions and related and derivatives of the present invention are implemented and effected by an innovative computer software and program invented and developed by the present patent applicant which were filed with and are stored in the Library of Congress in Washington, D.C. The present invention uses also the commercially available computer software (plural), programs and computer languages such as, but not limited to, those made and sold by Microsoft Corporation such as, but not limited to, Microsoft Windows Server, SQL such as, but not limited to Microsoft SQL Server, MySQL and the like, Internet Explorer, browsers, Web server, Apache, Microsoft IIS, Visual Studio and .Net, Microsoft software including .txt program and their derivatives and the like and their database, databases and derivatives, other computer corporations' and companies' programs, languages, codes and databases and their derivatives which are commonly and routinely used by computer engineers and programmers such as, but not limited to, PHP, PERL, C languages, such as, but not limited to, C, C+, C++, C#, JAVA, Java Script, AJAX, HTML, XHTML and the like and related and their derivatives. Other security software are such as, but not limited to, encryption-decryption of the information and data infra and their derivatives and products, processes and software, Firewall, anti-viral and related, Secure Sockets Layer (SSL) or Transport Layer Security (TLS) and related and the like and their derivatives.

The standard commercial hardware and equipment being used in the Internet network or networks such as, but not limited to, the Internet commerce are implemented and deployed per standard industrial practices and use hardware and equipment such as, but not limited to, computer servers and computers such as numerous HP and IBM servers, HP and Dell computers, Cisco routers and related, and various equipment including modems sold, lease, own and operate by cable companies such as, but not limited to, Time Warner and Optimum Online in New York, etc. Currently, HP ProLiant ML350 and ML110 Generation 4p Servers—see www.hp.com for details of the server hardware and internal design—and similar Dell server—see www.dell.com for details of the server hardware and internal design—used by the present patent applicant as the hardware wherein the computer programs and software (plural) mentioned herein operate. It is obvious and known that with more extensive operations and requirements, server blades and various hardware and equipment configurations, virtual servers such as those sold by VMware, HP and IBM, and their derivatives being used by many large American corporations can and will be used to implement the present invention.

It is understood that the present invention is also able to convert said words, terms, phrases and sentences into corresponding digits and further modify or adapt the database or databases to comprise of digits within the spirit and scope of the claims of the present invention.

It is understood that—by laws and medical ethics—each patient can only access and use such as, but not limited to, add and edit, and view his or her health and health-care information and data and, under the same setting, only physicians authorized by said patient are permitted and allow access to said patient's confidential health and health-care information and data infra. Corollary, each patient can view and feedback on information and data on health-care and health-care services and related payments, disbursements, credits, debits, deductions, disbursements, refunds or reimbursements and balances. Similarly, each physician can also view and feedback on the information and data on healthcare and health-care services and related payments, compensations and/or credits and year-to-date and total payments to his or her account. Similarly, each company or corporation or health-care buyer can also view and feedback on the disbursements, deductions and balances data pertinent to the company's, corporation's or health-care buyer's account.

It is understood that patients are or can be health-care consumers and health-care buyers and employers, companies, corporations and governments are health-care buyers although employers are or can be patients. Health-care providers are physicians and other people who provided health and health-related services to people. Furthermore, the present invention also encompasses and enables families such as, children and minors, and dependents—by said definition—to achieve the goals and objects of the present invention operating in the U.S.A. and other nations. For example, in one of numerous preferred embodiments of the present invention, a head of a household such as, but not limited to, a father who works for a company—both may contribute funds or pay into the funds to pay for said health-care services—can have his spouse, children, dependent and/or dependents to access and use said funds to pay for said health-care services use by them. Furthermore, in yet one of numerous preferred embodiments of the present invention, said spouse, children, dependent and/or dependents can also contribute and/or add his, her and/or their own money and resources to said funds or, along with said funds, also use his, her and/or their owns and/or respective employer's or employers' money and resources, etc. Thus, in the preferred embodiments of the present invention, the objectives and goals of the present invention are achieved for all parties.

It is understood that the terms health-care, health care and healthcare have the same meaning and application and that the terms computer server and server have the same meaning and application. Also, it is understood that the term software is used herein as singular and pleural.

It is understood that health-care resources, credits, funds, payments, disbursements, reimbursements, totals, balances, etc. used herein are such as, but not limited to, dollars and cents and other foreign currencies and instruments of payment.

Having described some of the preferred embodiments of the present invention, said embodiments of the present invention can be extended to embody and provide a platform for a barter system or an exchange as a means for paying or compensating physicians by health-care consumers or health-care buyers wherein health and health-care resources produce by, derived from or of physicians can be exchanged or bartered with non-health and non-health-care goods and services produced, performed by, derived from or of patients and health-care buyers. This is useful for people and health-care buyers with either no or limited financial resources but have unused, excess or over-produced goods and services and/or other resources such as, but not limited to, skills, trades, items or matters of value.

Although various preferred embodiments of the present invention have been described, it will be appreciated by those skilled in the art that adaptations and variations may be made without departing from the spirit and the scope of the claims of the present invention.

1. A method of generating, managing, accounting and displaying information and data on payments or compensations for health-care and health-care services provided to patients by physicians and on the deposits of and debits, deductions and/or disbursements from patients' and/or health-care buyers' deposits and/or funds corresponding to said payments or compensations to said physicians by and/or on the behalf of said patients and by and/or on the behalf of said health-care buyers wherein health, health-care and health-care-service information and data on or relating to said patients generated and submitted by said physicians comprising words and terms used and use by physicians of all and diverse medical and surgical practices or specialties for and in the communications of said information and data among and between said physicians and between physicians and patients and wherein said information and data including and comprising said words and terms generated, related and stored in said database or databases are available to said physicians' uses and/or generate by said physicians, wherein said physicians use computers and/or portable electronic communication devices in a network or networks of computers, portable electronic communication devices and computer server or servers wherein said computers and/or devices use by said physicians to generate and transmit said information and data are connected to, communicating with and to access the database or databases of said server or servers support by and using and operating commercially available computer programs and software and an innovative computer program and software means for relating said information and data and for processing, effecting and generating processes, productions, communications, outcomes and displays described herein invented and produced by the present patent applicant and deposited with the Library of Congress in Washington, D.C., wherein said health, health-care and health-care-service information and data are generated, related, entered into and stored in said database or databases wherein words and terms relate to said same, similar and/or equivalent words and terms used and/or generated by said physicians' and relating monetary values representing prices or monetary values of said health-care and health-care services generated, related and stored in said database or databases and used by said programs and software to relate, generate, manage, tally, account and display said information and data on payments, compensations, deposits, debits, deductions, disbursements and refunds, wherein said words and terms in said information and data generated and submitted by said physicians are related, manipulated and processed and to relate to said words and terms and relating monetary values generated, related and store in said database or databases by said computer programs and software, wherein said programs and software relate, generate, manage, compute, tally, account, effect and display said information and data on said payments, compensations, deposits, debits, deductions, disbursements and refunds, computations and derivatives, wherein said physicians are informed of erroneous information and data, wherein said erroneous information and data can be changed, corrected or edited by said physicians, wherein charges can be disputed by patients and payments are held in abeyance, wherein said patients' disputes can be responded by said physicians and payments are implemented, wherein said information and data on payments, computations and accounting of said payments or compensations to physicians and relating said words and terms and relating said information and data are related, retrieved and displayed to said physicians and wherein said information and data on deposits of and debits, deductions and/or disbursements and related said information and data are related, retrieved and displayed to said patients on the viewing screens of said electronic devices and are viewable and useable by said physicians and patients to benefit said physicians, patients and to improve the standard of living and quality of health-care and life of said people and to benefit said health-care buyers comprises:
a process of setting, operating and maintaining said network or networks of computers, portable electronic communication devices and computer server or servers and implementing wherein said computer programs and software and said innovative computer program and software means for said physicians to generate and transmit said information and data to said computer server or servers are implemented and working;
a process of using said information and data on health, health-care and health-care services generated and submitted by physicians;
a process of using relating, manipulating and processing said information and data on health, health-care and health-care services generated and submitted by physicians;
a process of relating, manipulating and processing said words and terms;
a process of inserting said information and data generated and submitted by physicians into said database or databases;
a process of generating, relating and storing said words and terms in said database or databases;
a process of generating, relating and storing said words and terms and relating monetary values, costs and/or prices in said database or databases;
a process of defining said words and terms for relating to same, similar and/or equivalent words and terms in said database or databases;
a process of relating, manipulating and processing said words and terms for relating information and data on health-care and health-care services;
a process of relating and inserting said words and terms for relating information and data on health-care and health-care services;
a process of relating said words and terms for relating information and data on health-care and health-care services in said information and data and same said words and terms generated, related and stored in said database or databases;
a process of relating said words and terms for relating data in said data on health-care services and similar and/or equivalent said words and terms generated, related and stored in said database or databases;
a process of matching and relating said words and terms generated by said physicians to same, similar and/or equivalent words and terms generated and stored in said database or databases;
a process of selecting matches of said words and terms in said process of matching and relating said words and terms;
a process of selecting said words and terms and relating monetary values;
a process of creating database or databases comprising accounts of physicians comprising information and data on payments, compensations, refunds and debits in said database or databases;
a process of creating database or databases comprising accounts of patients comprising deposits, debits, disbursements, refunds and credits in said database or databases;
a process of creating database or databases comprising accounts of health-care buyers comprising deposits, debits, disbursements, refunds and credits in said database or databases;
a process of inserting said words and terms and relating monetary values into said physicians' accounts;
a process of inserting said words and terms and relating monetary values into said patients' accounts;
a process of relating said data the credits representing payments credited to the physicians' accounts for the health-care services provided to patients by said physicians and said data on the debits, deductions or disbursements of funds representing payments for said services to said physicians from said patients' accounts in the database or databases;
a process of relating said data the credits representing payments credited to the physicians' accounts for the health-care services provided to patients by said physicians and said data on the debits, deductions or disbursements of funds representing payments for said services to said physicians from said health-care buyers' accounts in the database or databases;
a process of displaying said information and data on health-care and health-care services and related payments or compensations, debits, refunds, revenues and earnings to said physicians;
a process of displaying said information and data on health-care and health-care services and related deposits, debits, disbursements, refunds, credits and balances to patients;
a process of displaying data on deposits, debits or disbursements and balances to health-care buyers;
a process of correcting erroneous or inaccurate said information and data by physicians;
a process of correcting erroneous or inaccurate said information and data by physicians;
a process of feedbacks on said outcomes and/or products of said processes between said physicians and patients;
a process of storing said outcomes and products of said processes in said database or databases; and
a process of generating said databases.

2. A method of relating information and data on the payments, compensations and/or credits representing said payments or compensations to the physicians' accounts for payments of health-care and health-care services provided to patients by said physicians by and/or on the behalf of said patients and by and/or on the behalf of the health-care buyers and information and data on the deposits of patients and health-care buyers and patients' and health-care buyers' funds, debits, deductions and disbursements of said funds corresponding to said payments to said physicians viewable and useable by said physicians and patients, wherein said physicians generated information and data on health, health-care and health-care-service including and comprising words and terms used and use by physicians of all and diverse medical and surgical practices or specialties for and in the communications of said information and data on health, health-care and health-care-service including words and terms among and between said physicians and between physicians and patients using computers and/or portable electronic communication devices in a network or networks of computers, portable electronic communication devices and computer server or servers wherein said computers and/or devices use by said physicians to generate and transmit said information and data on health, health-care and health-care-service including words and terms are connected to, supported by and communicating with and accessing the database or databases of said server or servers support by and using and operating commercially available computer programs and software and an innovative computer program and software means for relating information and data and for processing, effecting and generating said processes, productions, communications, outcomes and displays described herein invented and produced by the present patent applicant and deposited with the Library of Congress in Washington, D.C., wherein said words and terms in said information and data generated and submitted by said physicians are related, manipulated and processed and to relate to words and terms and relating monetary values, costs or prices generated, related, entered into and store in said database or databases wherein words and terms relate to said same, similar and/or equivalent words and terms available to said physicians' uses and/or generate by said physicians and relating monetary values representing prices or monetary values of said health-care and health-care services generated, related and stored in said database or databases by said computer programs and software, wherein said words and terms are used to effect the insertions of related monetary values, prices or costs into physicians' accounts, and patients' and health-care buyers' accounts in said database or databases comprising said information and data including said information and data on said payments, compensations, credits, deposits, funds, debits, deductions and disbursements on said credits and payments credited to said physicians and relating to said debits or disbursements, data on deposits and debits or disbursements and balances relating to said payments of said patients' accounts and data on deposits and said debits and balances of funds relating to said payments or disbursements of said health-care buyers' accounts in a computer server or computer servers in a network or networks of computers and computer servers, wherein said information and data on health-care and health-care services and related payments or compensations and derivatives are viewable and monitored by said physicians and wherein said information and data on health-care and health-care services and related deposits, payments, disbursements, balances, refunds and credits and derivatives are viewable and monitored by said patients and, appropriately, by said health-care buyers and wherein feedbacks on said data between said physicians and patients are effected for the benefits of said physicians, patients and health-care buyers and wherein erroneous or inaccurate information and data can be corrected by said physicians, and wherein said information and data on payments, computations and accounting of said payments or compensations to physicians and relating said words and terms and relating said information and data are related, retrieved and displayed to said physicians and wherein said information and data on deposits of and debits, deductions and/or disbursements and related said information and data are related, retrieved and displayed to said patients on the viewing screens of said electronic devices and are viewable and useable by said physicians and patients to benefit said physicians, patients and to improve the standard of living and quality of health-care and life of said people and to benefit said health-care buyers comprises:
a process of setting, operating and maintaining said network or networks of computers, portable electronic communication devices and computer server or servers and implementing wherein said computer programs and software and said innovative computer program and software means for said physicians to generate and transmit said information and data to said computer server or servers are implemented and working;
a process of using said information and data on health, health-care and health-care services generated and submitted by physicians;
a process of using relating, manipulating and processing said information and data on health, health-care and health-care services generated and submitted by physicians;
a process of relating, manipulating and processing said words and terms;
a process of inserting said information and data generated and submitted by physicians into said database or databases;
a process of generating, relating and storing said words and terms in said database or databases;
a process of generating, relating and storing said words and terms and relating monetary values, costs and/or prices in said database or databases;
a process of defining said words and terms for relating to same, similar and/or equivalent words and terms in said database or databases;
a process of relating, manipulating and processing said words and terms for relating information and data on health-care and health-care services;
a process of relating and inserting said words and terms for relating information and data on health-care and health-care services;
a process of relating said words and terms for relating information and data on health-care and health-care services in said information and data and same said words and terms generated, related and stored in said database or databases;
a process of relating said words and terms for relating data in said data on health-care services and similar and/or equivalent said words and terms generated, related and stored in said database or databases;
a process of matching and relating said words and terms generated by said physicians to same, similar and/or equivalent words and terms generated and stored in said database or databases;
a process of selecting matches of said words and terms in said process of matching and relating said words and terms;
a process of selecting said words and terms and relating monetary values;
a process of creating database or databases comprising accounts of physicians comprising information and data on payments, compensations, refunds and debits in said database or databases;
a process of creating database or databases comprising accounts of patients comprising deposits, debits, disbursements, refunds and credits in said database or databases;
a process of creating database or databases comprising accounts of health-care buyers comprising deposits, debits, disbursements, refunds and credits in said database or databases;
a process of inserting said words and terms and relating monetary values into said physicians' accounts;
a process of inserting said words and terms and relating monetary values into said patients' accounts;
a process of relating said data the credits representing payments credited to the physicians' accounts for the health-care services provided to patients by said physicians and said data on the debits, deductions or disbursements of funds representing payments for said services to said physicians from said patients'accounts in the database or databases;
a process of relating said data the credits representing payments credited to the physicians' accounts for the health-care services provided to patients by said physicians and said data on the debits, deductions or disbursements of funds representing payments for said services to said physicians from said health-care buyers' accounts in the database or databases;
a process of displaying said information and data on health-care and health-care services and related payments or compensations, debits, refunds, revenues and earnings to said physicians;
a process of displaying said information and data on health-care and health-care services and related deposits, debits, disbursements, refunds, credits and balances to patients;
a process of displaying data on deposits, debits or disbursements and balances to health-care buyers;
a process of correcting erroneous or inaccurate said information and data by physicians;
a process of correcting erroneous or inaccurate said information and data by physicians;
a process of feedbacks on said outcomes and/or products of said processes between said physicians and patients;
a process of storing said outcomes and products of said processes in said database or databases; and
a process of generating said databases.

3. A system of controlling health-care resources by physicians, patients and health-care buyers wherein words and terms on health-care and health-care services which are integral components of health, health-care and health-care service information and data used, use and generate by physicians of all and diverse medical and surgical practices or specialties for and in the communications of said information and data among and between said physicians and between physicians and patients and said information and data, wherein said information and data including said words and terms generated and submitted by said physicians are related, manipulated and processed and to relate to said same, similar and/or equivalent words and terms and relating monetary values generated, related, entered into and store in said database or databases, wherein said words and terms are used for generating, managing, accounting and displaying information and data on payments or compensations for health-care and health-care services provided to patients by physicians and on the deposits of and debits, deductions and/or disbursements from patients' and health-care buyers' deposits and/or funds corresponding to said payments or compensations for said health-care and health-care services to said physicians by and/or on the behalf of said patients and by and/or on the behalf of said health-care buyers, a network or networks of computers, portable electronic communication devices and computer server or servers wherein said computers and/or devices are used by said physicians to generate and transmit said information and data which are related and inserted into the database or databases of said computer server or servers and wherein said computers and/or devices are connected to, supported by and communicating with and accessing the database or databases of said server or servers support by and using and operating commercially available computer programs and software and an innovative computer program and software means for inserting said information and data into said database or databases and for relating said information and data and for processing, effecting and generating said processes, productions, communications, outcomes and displays described herein invented and produced by the present patent applicant and deposited with the Library of Congress in Washington, D.C., wherein said system comprises said innovative computer program and software means for processing, manipulating, relating and inserting said information and data into said database or databases and for relating said information and data and for processing, effecting and generating said processes, productions, communications, outcomes and displays invented and produced by the present patent applicant and deposited with the Library of Congress in Washington, D.C., wherein said information and data are viewable, monitored and used by said physicians and patients and, in appropriate settings or circumstances, by said health-care buyers, to control the health-care resources to benefit said physicians, health-care consumers and buyers to improve the standard of living and quality of health-care and life of said people comprises:
said information and data including said words and terms generated and submitted by said physicians;
said words and terms on health-care and health-care services generated and submitted by said physicians;
said same, similar and/or equivalent words and terms generated, related, entered into and store in said database or databases;
said same, similar and/or equivalent words and terms and relating monetary values, prices or costs generated, related, entered into and store in said database or databases;
said network or networks of computers, portable electronic communication devices and computer server or servers;
a computer program and software means for effecting the generations of information and data on health, health-care and health-care services by physicians and the submissions of said information and data to said database or databases of said computer server or servers;
a computer program and software means for manipulating and processing said information and data on health-care and health-care services generated by physicians to conform to information and data on health-care and health-care services stored in said database or databases;
a computer program and software means for generating, relating and storing said words and terms on health-care and health-care services in said database or databases;
a computer program means for relating manipulating and processing said information and data generated by said physicians in said computer server or servers;
a computer program means for relating, inserting and storing said information and data generated by said physicians in said computer server or servers;
a computer program and software means for generating said words and terms on health-care and health-care services and relating monetary values of said health-care and health-care services and relating, inserting and storing said information and data in said database or databases;
a computer program and software means for inserting said information and data into said database or databases;
a computer program and software means for relating said information and data;
a computer program and software means for manipulating and processing said words and terms;
a computer program and software means for relating said words and terms generated by said physicians and said same, similar and/or equivalent words and terms and relating monetary values generated, related, entered into and store in said database or databases;
a computer program and software means for using said words and terms for generating, managing, accounting and displaying said words and terms and related information and data on payments or compensations for health-care and health-care services provided to patients by physicians and on the deposits of and debits, deductions and/or disbursements from patients' and health-care buyers' deposits and/or funds corresponding to said payments or compensations for said health-care and health-care services to said physicians by and/or on the behalf of said patients and by and/or on the behalf of said health-care buyers on the viewing screens of said computers and/or devices;
a computer program and software means for computing and accounting said payments or compensations, debits, deductions and/or disbursements;
a computer program and software means for computing and accounting said debits, deductions and/or disbursements;
a computer program and software means for inserting said computations, tallies and derivatives into said database or databases;
a computer program and software means for displaying data on health-care and health-care services and related payments or compensations and total payments or compensations to said physicians;
a computer program and software means for displaying said payments or compensations, deposits, debits, deductions, disbursements, computations, tallies and derivatives on the viewing screens of said computers and/or said devices;
a computer program and software means for displaying data on health-care services and related payments, debits and balances to said patients;
a computer program and software means for displaying payments, debits and balances to health-care said buyers;
a computer program and software means for relating and using said information and data on health-care services generated by said physician and said same, similar and/or equivalent information and data and relating monetary values to effect the generations of information and data on physicians' accounts comprising information and data on credits and/or payments to said physicians for said health-care services provided to said patients;
a computer program and software means for relating and using said information and data on health-care services and said same, similar and/or equivalent information and data and relating monetary values to effect the generations of information and data on said patients' accounts comprising information and data on the debits, disbursements of funds, refunds and credits of said patients' accounts relating to said data on said credits or payments;
a computer program and software means for using said data on health-care services, said same, similar or equivalent data on health-care services and relating monetary values to effect the generations of said data on health-care buyers' accounts comprising data on the disbursements of funds of said buyers' accounts relating to said data on said credits or payments and disbursements;
a computer program and software means for generating equivalent data as said processed data on health-care services in said database or databases;
a computer program and software means for generating said data and relating monetary values in said database or databases;
a computer program and software means for scanning said information and data on health-care services;
a computer program and software means for matching said words and terms generated by said physicians with said words and terms store in said database or databases;
a computer program and software means for selecting said words and terms and relating monetary values;
a computer program and software means for inserting said words and terms and relating monetary values into said physicians' accounts in said database or databases;
a computer program and software means for inserting said words and terms and relating monetary values into said patients' accounts in said database or databases;
a computer program and software means for creating database or databases comprising data on the credits and payments credited to said physicians;
a computer program and software means for creating database or databases comprising data on said debits, deductions, disbursements and balances;
a computer program and software means for relating said credits and payments, debits, deductions, disbursements and balances;
a computer program and software means for relating data on the credits representing payments credited to the physicians' accounts for the health-care services provided to patients by said physicians and data on the debits, deductions or disbursements of funds representing payments for said services to said physicians from said patients' accounts in said database or databases; a computer program and software means for relating said data on the deposits of funds, transfers of funds, debits, deductions or disbursements, refunds and balances in said patients' and health-care buyers' accounts in said database or databases;
a computer program and software means for allowing physicians to correct erroneous or inaccurate information and data;
a computer program and software means for displaying feedbacks on the outcomes of said processes to said physicians and patients;
a computer program and software means for storing the outcomes of said processes in said database or databases; and
a computer program and software means for generating said databases.
